(19) United States
(12) Patent Application Publication
(10) Pub. No.: US 2007/0170289 A1
(43) Pub. Date: Jul. 26, 2007

(54) Garbage disposal apparatus

(75) Inventors: Takemasu Okada, Fukuoka (JP); Kenichi Ogata, Fukuoka (JP); Yoshimitsu Kora, Fukuoka (JP); Takeshi Shimizu, Fukuoka (JP); Makoto Hatakeyama, Fukuoka (JP); Kuniaki Shinohara, Fukuoka (JP); Yoshimasa Koumatsu, Fukuoka (JP)

Correspondence Address: CARRIER BLACKMAN AND ASSOCIATES, 24101 NOVI ROAD, SUITE 100, NOVI, MI, 48375, US

(73) Assignee: TOTO LTD., Kita-Kyusyu-Shi, Fukuoka (JP)

(21) Appl. No.: 10/589,072

(22) PCT Filed: Feb. 2, 2005
(86) PCT No.: PCT/JP05/01490

§ 371 Date: Aug. 9, 2006

(30) Foreign Application Priority Data
Feb. 10, 2004 (JP) 2004-033546
Mar. 31, 2004 (JP) 2004-106782

(51) Int. Cl. B02C 23/36

(52) U.S. Cl. 241/46.013

(57) ABSTRACT

A garbage disposal apparatus includes a garbage disposition port, a storage chamber communicating with this garbage disposition port to store uncrushed garbage and into which flushing water is supplied, a crushing section provided adjacent to the storage chamber and having a crushing mechanism and a clearance for passing therethrough garbage crushed by the crushing mechanism, a discharge section provided in communication with the clearance and having a discharge port for externally discharging the garbage crushed by the crushing section, a driving mechanism for driving the crushing mechanism, a mechanism for controlling the amount of garbage passing through the clearance per unit of time, and a mechanism provided at the discharge section or on the downstream side of the discharge section for controlling the amount of garbage discharged within the discharge section or on the downstream side of the discharge section.

### BACKGROUND OF THE INVENTION

1. Field of the Invention

The present invention relates to a garbage disposal apparatus for crushing and discharging garbage produced in a general household kitchen or a kitchen for use in business, and more particularly to a garbage disposal apparatus adapted to improve the discharge performance of the garbage containing long fibrous materials.

2. Description of the Prior Art

Garbage containing long fibrous materials such as bean husks is likely to still contain long fibers even though a disposer is used for disposal. This garbage often intertwines with other materials and is likely to cause clogging.

Patent Document 1 proposes that the garbage be discharged in a short period of time by continuously operating a motor which rotates a crushing means.

Patent Document 2 proposes that an impeller be provided on the under surface of a turntable within a disposer. With provision of the disposer, the flow velocity of discharged water into a discharge port is increased to accelerate the discharge of garbage from the discharge port.

Patent Document 3 also proposes that a turntable be caused to intermittently rotate within a disposer to prevent clogging at a discharge port or at a trap section on the downstream side of the discharge port.

[Patent Document 1] Japanese Patent Application Publication No. 2003-80102 (FIG. 1 of page 3)

[Patent Document 2] Japanese Patent No. 3420305 (FIG. 3 of page 5)

[Patent Document 3] Japanese Patent Application Publication No. 2002-204972 (FIG. 3 of page 6)

Referring to Patent Document 1, the motor is continuously driven, but the garbage containing long fibrous materials is often discharged as is (in the long condition) without being fully crushed. In particular, since a large amount of this garbage is discharged all at once in the initial stage of operation, it often intertwines with other materials to form a clot at the discharge port or within the trap on the downstream side of the discharge port and causes clogging.

Referring to Patent Document 2, even a simple provision of the impeller contributes to the improvement in the discharge performance of the garbage, but it is not effective for crushing garbage containing long fibrous materials. In this case, the long fibrous garbage is rather discharged as is without being fully crushed, to cause clogging.

Referring to Patent Document 3, the intermittent operation of a motor can improve the clogging more than in the continuous operation. However, if an attempt is made to solve the clogging only by the intermittent operation, the operating time becomes extremely long and makes the garbage disposal apparatus inconvenient.

### SUMMARY OF THE INVENTION

It is therefore an object of the present invention to solve the problems stated above and to provide a garbage disposal apparatus in which garbage does not clog a discharge port or a trap continuing into the discharge port and which can crush and discharge the garbage in a comparatively short period of time.

In order to attain this object, a garbage disposal apparatus according to claim 1 comprises a garbage disposition port; a storage chamber communicating with the garbage disposition port to store uncrushed garbage therein and into which flushing water is supplied; a crushing section provided adjacent to the storage chamber and having a crushing means and a clearance for passing therethrough the garbage crushed by the crushing means; a discharge section provided in communication with the clearance and having a discharge port for externally discharging the garbage crushed by the crushing section; a driving means for driving the crushing means; a means for controlling the amount of garbage passing through the clearance per unit of time; and a means provided at the discharge section or on the downstream side of the discharge section for controlling the amount of garbage discharged within the discharge section or on the downstream side of the discharge section.

As described above, by disposing a means for controlling the discharge amount of garbage at a discharge section or on the downstream side of the discharge section, garbage containing long fibrous materials does not clog a discharge port or a trap continuing into this discharge port and thus, crushing and discharging processes can be performed in a comparatively short period of time.

For example, if the means for controlling the amount of garbage passing through the clearance per unit of time is driven in synchronization with the means for controlling the amount of garbage discharged within the discharge section or on the downstream side of the discharge section so as to bring the concentration of crushed garbage in the discharged water close to a steady value for a predetermined time from the start to the end of discharge, the concentration of garbage discharged in the initial stage does not become high (thick) and clogging can be prevented. The crushed garbage concentration means the amount of the crushed garbage discharged included in the discharged water per unit of time.

Further, a crush control means for controlling the drive condition of the crushing means is available as the means for controlling the amount of garbage passing through the clearance per unit of time. More specifically, a motor control section controls the speed of revolution and the time of revolution of the crushing means.

The crushing means can be composed of a turntable adapted to rotate by a motor and a rotary blade mounted on the turntable. The rotary blade can be a hammer which is swung radially outward (on the outer diameter side in the radial direction) by centrifugal force. In this manner, by mounting the rotary blade on the turntable, garbage can be efficiently crushed between the rotary blade and a fixed blade provided on the inner wall of a disposer.

The means for controlling the amount of garbage passing through the clearance per unit of time is an automatic feed water means for adjusting (increasing or decreasing) the amount of flushing water supplied to the storage chamber. In this manner, by providing the automatic feed water means, the amount of flushing water supplied can be increased, for example, in the initial stage, to keep the concentration of the garbage low.

The means for controlling the amount of garbage passing through the clearance per unit of time can be a clearance adjusting means for varying the size of the clearance. Specifically, a member which is swung outward by the centrifugal force to narrow the clearance can be provided on the outer periphery of the turntable.

Further, the means for controlling the amount of garbage passing through the clearance per unit of time can be a garbage disposition amount regulating means for regulating the amount of garbage supplied to the crushing section which is provided in the storage chamber, and a control means for controlling this garbage disposition amount regulating means. By controlling the garbage disposition amount regulating means so as not to provide a large amount of garbage on the downstream side at one time, clogging can be controlled.

Still further, the means for controlling the amount of garbage discharged within the discharge section or on the downstream side of the discharge section can be an impeller adapted to rotate integrally with or separately from the crushing means. The discharge amount can be accelerated by the provision of the impeller to achieve shortening of the crush and discharge processing time. By synchronizing the drive of the impeller with that of the means for controlling the amount of garbage passing through the clearance, so as to increase the discharge amount of garbage within the discharge section or on the downstream side of the discharge section in response to the decrease in the amount of garbage passing through the clearance, homogenization in the crushed substance concentration is achieved and thus, clogging can be prevented.

Referring to the angle of the impeller, if the front end section of the impeller is situated radially inside (on the inner diameter side in the radial direction) and the rear end section is situated radially outward (on the outer diameter side in the radial direction) to be set back from the radial direction of the front section, the garbage can be pushed radially outward (on the outer diameter side in the radial direction) and thus, clogging can be prevented. The impeller's shape is not limited to a straight plate shape, but can be a curved-shape.

The means for controlling the amount of garbage discharged within the discharge section or on the down stream side of the discharge section can be a water supply means for emitting a jet of water toward the discharge port. If the emitting direction of a jet of water by this water supply means is the direction to accelerate the flow to the discharge port, the discharge effect improves. In particular, if the water supply means is used in conjunction with the impeller, the discharge effect further improves.

By synchronizing the water supply means with the means for controlling the amount of garbage passing through the clearance so as to increase the amount of garbage discharged within the discharge section or on the downstream side of the discharge section in response to the decrease in the amount of garbage passing through the clearance, homogenization in the crushed substance concentration is achieved and thus, clogging can be prevented.

Further, the means for controlling the amount of garbage discharged within the discharge section or on the downstream side thereof can be a water supply means for emitting a jet of water from a predetermined direction to a trap section on the downstream side of the discharge section. Since the trap section is provided with the water supply means, it is not only effective for discharge acceleration, but also for prevention of clogging.

By synchronizing the water supply means with the means for controlling the amount of garbage passing through the clearance so as to increase the amount of garbage discharged within the discharge section or on the downstream side of the discharge section in response to the decrease in the amount of garbage passing through the clearance, homogenization in the crushed substance concentration is achieved and thus, clogging can be prevented.

Referring to an operation pattern of the garbage disposal apparatus according to the present invention, the crush control means for controlling the drive condition of the crushing means is a motor control section for controlling the speed of revolution and the operating time of the crushing means, and the control by this motor control section is a variable operation whereby stoppage, low speed revolution. or high speed revolution are rotatingly repeated.

In the case where an AC motor is used, on/off control is a main operation. However, when a DC motor is used, control of the number of revolutions can be easily conducted. Thus, by using the DC motor, it is possible to easily conduct not only a variable operation of stoppage or high speed revolution, but also a variable operation of low speed revolution or high speed revolution.

In this manner, by conducting a variable operation, it is possible to lower the garbage concentration, especially in the initial stage of operation, and prevent clogging. In particular, by interposing a reverse operation therebetween, it is possible to unravel the fibrous garbage once entangled.

Further, the control by the motor control section is a variable operation whereby stoppage, low speed revolution, or high speed revolution are alternately repeated, and the operating time of the last or proximate high speed revolution is set longer than that of other high speed operations. With this arrangement, since the amount of garbage discharged becomes large in a condition in which the garbage concentration is comparatively thin, it is possible to shorten the entire operating time.

By feeding a high amount of water from a feed water control section to the crushing section immediately after the start of variable operation, the entire discharge flow rate of the feed water and the garbage can be made large. In this manner, it is possible to control the rise of the garbage concentration in the initial stage of discharge, which is the cause of the garbage clogging.

Further, once the amount of feed water from the feed water control section to the crushing section is stopped in the middle of variable operation, the crushing effect increases for garbage such as grapefruit peel which floats in the crushing section due to its light specific gravity and is crushed with difficulty.

Still further, if, after the end of variable operation, the amount of feed water from the feed water control section to the crushing section is continued for a predetermined time, the cleansing effect to the inside increases and as a result, possible pipe clogging can be surely prevented.

### BRIEF DESCRIPTION OF THE DRAWINGS

The above and other objects, features and advantages of the present invention will become more apparent from the following description when taken in conjunction with the accompanying drawings.

FIG. 1 is an entire structural view of a garbage disposal apparatus according to the present invention;

FIG. 2 is a cross-sectional view of a disposer constituting a part of the garbage disposal apparatus;

FIG. 3 is a schematic view of the disposer showing an example in which an opening adjusting means is used as a means to regulate the amount of garbage disposition;

FIG. 4 is a schematic view of the disposer showing an example in which a pre-crushing means is used as a means to regulate the amount of garbage disposition;

FIG. 5 is a schematic view of the disposer showing an example in which an automatic feed water means is provided with a water sensor;

FIG. 6 is a schematic view of the disposer showing an example in which the automatic feed water means is a tornado-type water feeder;

FIGS. 7(a) and (b) are schematic views of the disposer showing an example in which a centrifugal fin is used as a means for controlling the amount of garbage passing through a clearance per unit of time;

FIG. 8 is a perspective view showing an example in which an impeller is used as a means for controlling the amount of garbage discharged within a discharge section or on the downstream side of the discharge section;

FIG. 9 is a view similar to FIG. 8 showing another embodiment of the impeller;

FIG. 10 is a schematic view showing still another embodiment in which a normal and reverse rotation type impeller is used;

FIGS. 11(a) through (e) are views describing examples in which a water supply means (i.e., a discharge section jet) for emitting a jet of water is used as a means for controlling the amount of garbage discharged;

FIGS. 12(a) through (c) are views describing examples of another water supply means (i.e., a discharge section jet);

FIG. 13 is a view describing an example in which a trap section is provided with a water supply means for emitting a jet of water;

FIG. 14 is a view describing an example in which the shape of the trap section serving as a means for controlling the amount of garbage discharged is changed;

FIG. 15 is a view describing an example in which the volume of a discharge section is made variable as a means for controlling the amount of garbage discharged;

FIG. 16a is a view showing an operation pattern of a garbage disposal apparatus in which the ON/OFF state of a driving motor and the feed water amount are varied, wherein the ON/OFF state of the driving motor is repeated so that the number of revolutions drops to 0 in the OFF state of the driving motor;

FIG. 16b is a view showing an operation pattern of the garbage disposal apparatus in which the ON/OFF state of a driving motor and the feed water amount are varied, wherein the ON/OFF state of the driving motor is repeated so that the number of revolutions does not drop to 0 in the OFF state of the driving motor;

FIG. 16c is a view showing an operation pattern of the garbage disposal apparatus in which the ON/OFF state of the driving motor and the feed water amount are varied, wherein the number of revolutions of the driving motor varies in the ON state of the driving motor;

FIG. 17 is a graph comparing the relationship between the concentration of crushed materials passing through the clearance and the time from the start of driving, in the continuous operation with an impeller, the continuous operation without the impeller, the variable operation with the impeller, and variable operation without the impeller;

FIG. 18a is a view showing another embodiment of the operation pattern in which the number of revolutions in the high-speed revolution is constant;

FIG. 18b is a view showing a still further embodiment of the operation pattern in which part of the high-speed revolutions is partly included;

FIG. 19 is a view showing another embodiment of the operation pattern;

FIG. 20 is a view showing still another embodiment of the operation pattern;

FIG. 21 is a view showing a further embodiment of the operation pattern; and

FIG. 22 is a view showing a still further embodiment of the operation pattern.

### DETAILED DESCRIPTION OF THE PREFERRED EMBODIMENTS

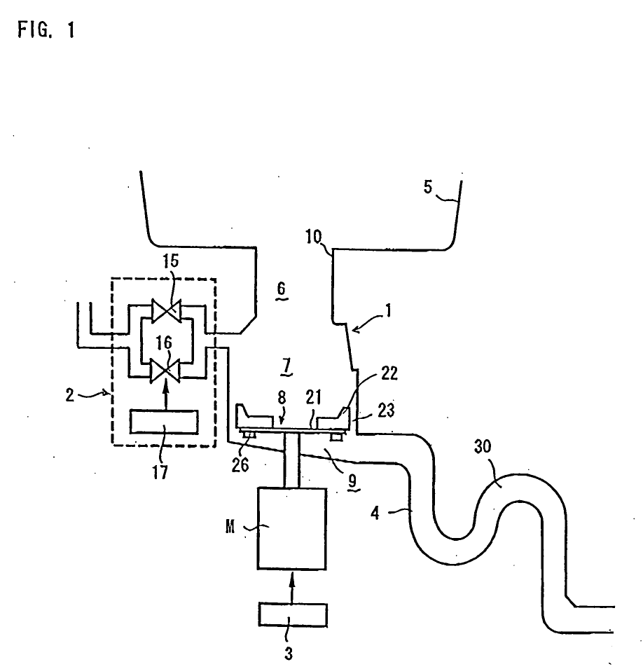

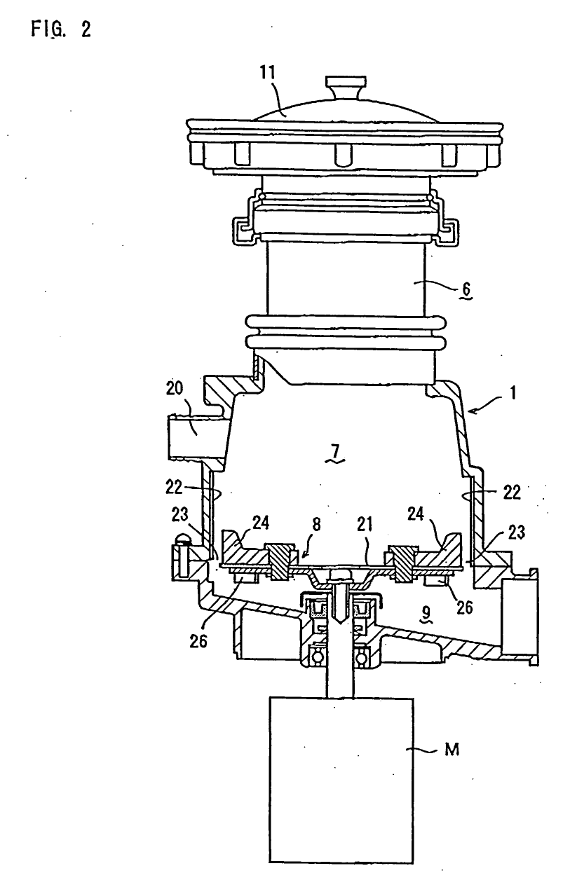

A preferred embodiment of the present invention will now be described with reference to the accompanying drawings. FIG. 1 is an entire structural view of a garbage disposal apparatus according to the present invention and FIG. 2 is a cross-sectional view of a disposer constituting a part of the garbage disposal apparatus.

The garbage disposal apparatus comprises a disposer body 1, a feed water section 2 for supplying water to this disposer body 1, a motor section 3 for controlling a motor M incorporated in the disposer body 1, and a discharge pipe line 4 for discharged water including crushed garbage.

The disposer body 1 is provided with a garbage disposition section 6 of which the upper section is open on the bottom surface of a sink 5, a garbage storing chamber 7 which occupies the lower area of the garbage disposition section 6, a crushing section 8 which occupies the lower area of the garbage storing chamber 7, and a discharge section 9 which occupies the lower area of the crushing section 8 to communicate with the discharge pipe line 4.

The upper end section of the garbage disposition section 6 is provided with an opening 10 to the sink 5. Detachably provided on the opening 10 is a cover body 11. The opening 10 is closed by the cover body 11 when the garbage disposal apparatus is not used, to prevent a fork or a spoon from dropping in the disposer body 1. There is also provided a mechanism so that the motor M is not driven unless the opening 10 is closed by the cover body 11 to assure safety.

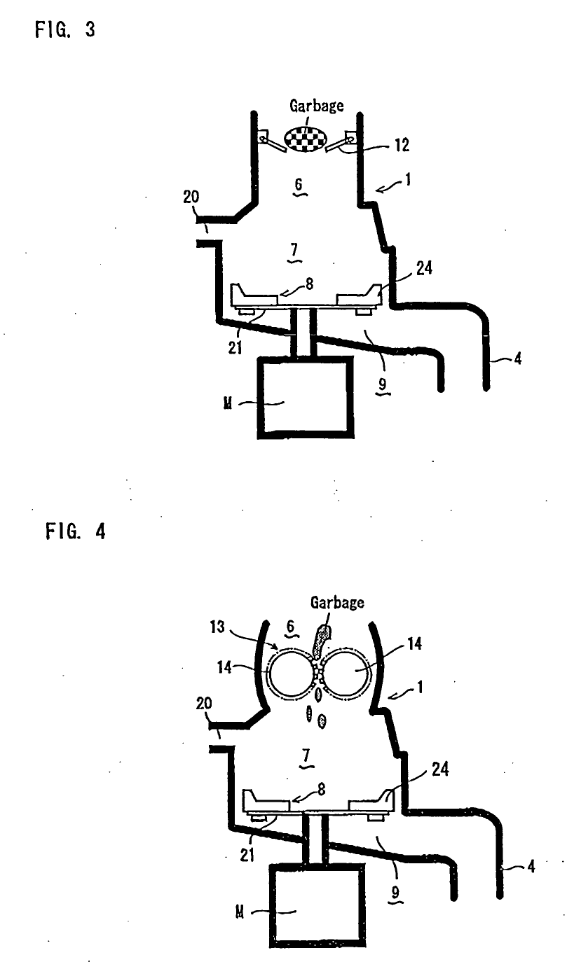

FIG. 3 is a schematic view of a disposer showing another embodiment of the garbage disposition section 6. In this embodiment, a valve body 12 of which the opening is adjustable is provided within the garbage disposition section 6 to control the amount of garbage deposited into the garbage storing chamber 7 of the disposer body 1. In this manner, by controlling the disposition amount, it is possible to prevent a large amount of garbage from being crushed at one time and gathering around the discharge port.

FIG. 4 is a schematic view of a disposer showing still another embodiment of the garbage disposition section 6. In this embodiment, a pre-crushing section 13 is provided within the garbage disposition section 6. This pre-crushing section 13 is composed of a pair of crushing teeth 14 and 14 which mesh with each other to rotate and are adapted to set limits on the amount of garbage thrown into the garbage storing chamber 7. This pre-crushing section 13 also crushes to pieces garbage such as a bone which is crushed with difficulty, to lighten the burden of the crushing section 8 and prevents large pieces of garbage from flowing downstream.

Referring back to FIG. 1, a feed water opening from a feed water section 2 is open on the wall surface of the garbage storing chamber 7. This feed water section 2 has a first feed water valve 15 and a second feed water valve 16 made of a solenoid valve, respectively. These first and second feed water valves 15 and 16 are switched by a signal from a feed water control section 17. In other words, by combining the ON/OFF control of these feed water valves 15 and 16 and varying the amount of water supplied, it is possible to provide an automatic feed water means for controlling the amount of feed water to the garbage storing chamber 7 to four (4) levels.

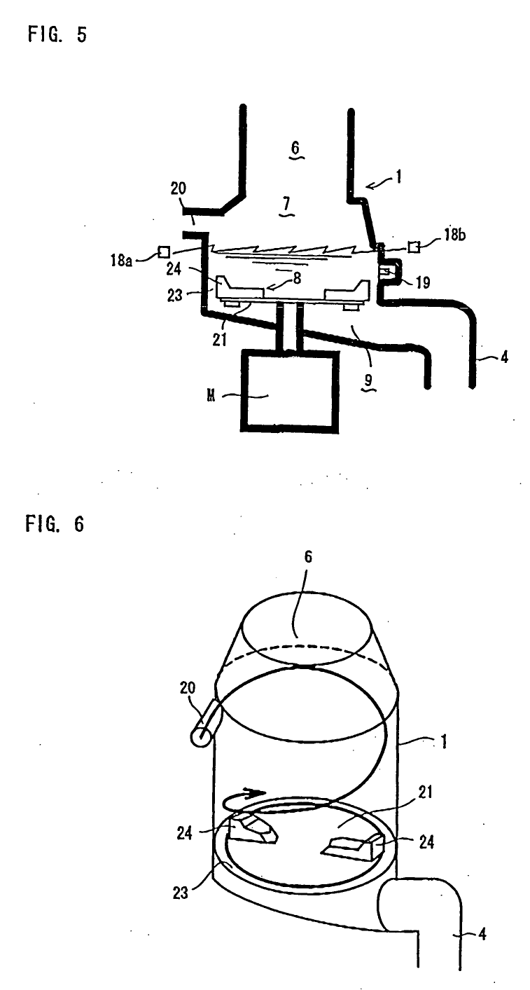

In the case of the automatic feed water means, it is possible to control the feed water amount (water supply) by detecting the water level within the garbage storing chamber 7 and determining the approximate ratio of the garbage and water. For this purpose, as shown in FIG. 5, a transmitter section 18a and a receiver section 18b of a microwave sensor are disposed outside the disposer body 1 or a recessed section is provided on the inner side of the wall surface of the garbage storing chamber 7 to dispose a pressure sensor therein.

FIG. 6 is a perspective view of a feed water port 20 section of the feed water section 2 as seen from the upper side of the disposer. The axis line of the feed water port 20 is arranged in a direction substantially along (parallel to) the wall surface of the garbage storing chamber 7. With this arrangement, feed water forms a vortex within the garbage storing chamber 7 capable of effectively preventing the garbage from being deposited on the wall surface and of controlling the amount of garbage passing through a clearance 23 by controlling the feed water amount.

Referring back to FIG. 2, the crushing section 8 is provided with a turntable 21 serving as a crushing means, and the clearance 23 is made between this turntable 21 and a fixed blade 22 provided on the inner wall surface of the crushing section 8 to pass the crushed garbage therethrough.

Since the amount of garbage passing through this clearance 23 per unit of time has an influence on the clogging, the amount of feed water provided by the feed water section 2 or the amount of garbage thrown into a throwing section are controlled.

Mounted at an angle of 180□ on the upper surface of the turntable 21 is a pair of hammers 24 functioning as a crushing blade. The hammer 24 has a small edge section and a large edge section. The small edge section is rotatably supported on the turntable 21 through an axis, while the large edge section is swung outward by centrifugal force during rotation to crush the garbage between the hammer 24 and the fixed blade 22. The shape of hammer 24 is not limited to the type with the small edge section and the large edge section.

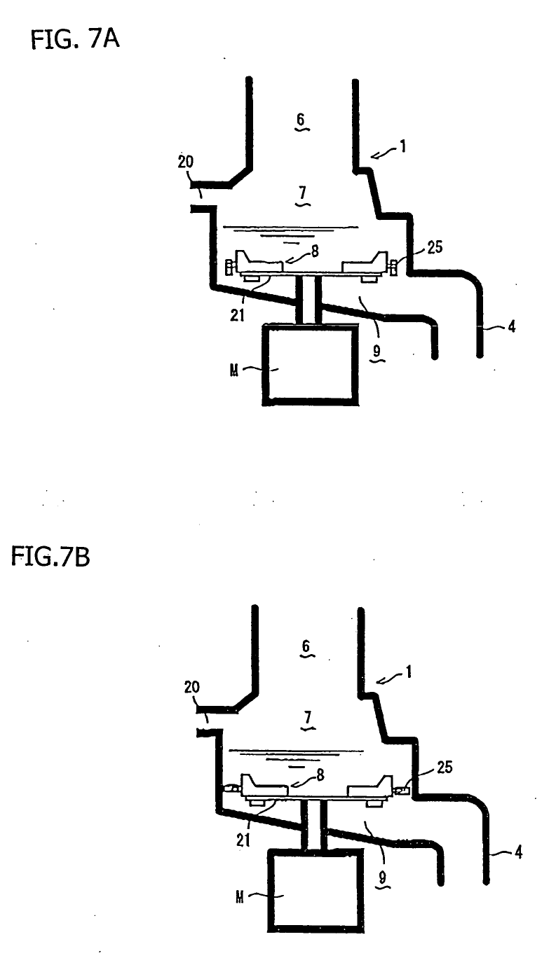

FIGS. 7(a) and (b) are views showing another embodiment in which the clearance 23 is changed. In this embodiment, a fin 25 is installed on the outer periphery of the turntable 21. As shown in FIG. 7(b), the fin 25 is swung outward by centrifugal force during rotation of the turntable 21 to narrow the clearance 23. On the other hand, as shown in FIG. 7(a), the fin 25 hangs down when the turntable 21 stops, to broaden the clearance 23.

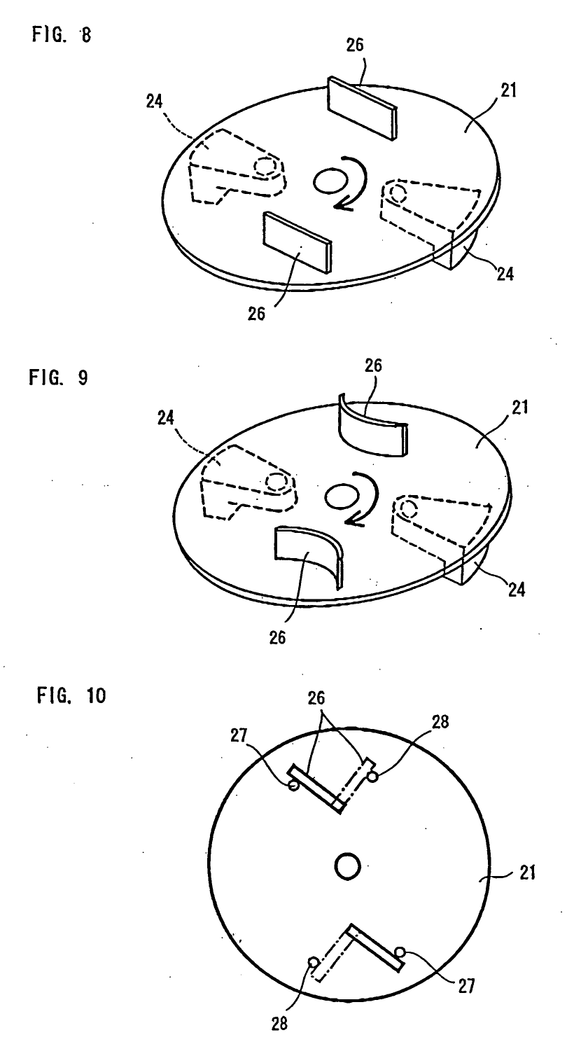

FIG. 8 is a perspective view showing the reverse side of the turntable 21. A pair of impellers 26 is mounted on the reverse side of the turntable 21. The impellers 26 are dephased at an angle of 90□ from the hammers 24 to achieve a balance. The impellers 26 are not necessarily mounted on the reverse side of the turntable 21, but can be formed as a separate body from the turntable 21 to rotate independently.

In order to accelerate the amount of garbage discharged within the discharge section 9 or on the downstream side of the discharge section 9, the impellers 26 are mounted at such an installation angle that the front end section is situated radially inside (on the inner diameter side in the radial direction) relative to the rotational direction and the rear end section is situated radially outward (on the outer diameter side in the radial direction) to be set back from the radial direction of the front end section. As shown in FIG. 9, the shape of the impeller 26 itself can be curved with the rear side bulging relative to the rotational direction.

FIG. 10 is a view describing another embodiment of the impeller. In this embodiment, one end of the impeller 26 is rotatably supported around an axis and stoppers 27 and 28 for controlling the rotational limit of the impeller are provided on the reverse side of the turntable. The impeller 26 touches the stopper 27 during normal rotation and touches the stopper 28 during reverse rotation so that the garbage is always pushed radially outward (on the outer diameter side in the radial direction) and the amount discharged is accelerated.

Further, the bottom surface of the discharge section 9 is inclined toward the discharge pipe line 4 which is connected from the radial direction of the discharge section 9 or from the tangential direction of the discharge section 9.

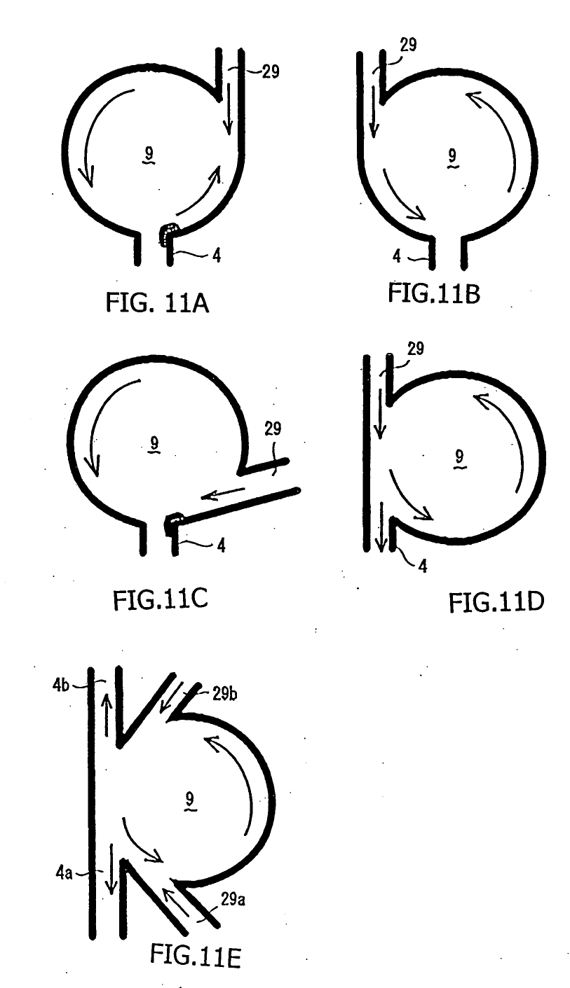

FIGS. 11(a) through (e) are views describing an example in which a water supply means (a discharge section jet) 29 for emitting a jet of water is used as a means for controlling the amount of garbage discharged to the discharge pipe line 4. In an example as shown in FIG. 11(a), a jet of water is emitted in a direction opposite to a spiral flow within the discharge section 9 to have a structure in which depositing of the garbage can be eliminated when the rotation of the turntable is in the OFF state. In an example as shown in FIG. 11(b), a jet of water is emitted in the forward direction to the spiral flow within the discharge section 9 to provide a structure in which the flow rate of the spiral flow within the discharge section 9 is maintained to improve the discharge performance when the rotation of the turntable is in the OFF state. An example as shown in FIG. 11(c) has a structure in which a jet of water is emitted toward a section where fibrous garbage is easily caught in a connecting section of the discharge pipe line 4 when the rotation of the turntable is in the OFF state. An example shown in FIG. 11(d) has a structure in which the discharge pipe line 4 is connected in the tangential direction of the discharge section 9 and the discharge section jet 29 is connected in the same direction as the discharge pipe line 4 to maintain the flow rate of the spiral flow within the discharge section 9, thereby improving the discharge performance. An example as shown in FIG. 11(e) has a structure in which a discharge pipe line 4a and a discharge pipe line 4b are connected, and a discharge section jet 29a and a discharge section jet 29b are connected, wherein the discharge section jet 29a emits water during normal rotation of the turntable to prevent the depositing of the garbage and discharges the garbage from the discharge pipe line 4a, while the discharge section jet 29b emits water during reverse rotation of the turntable to prevent the depositing of the garbage and discharges the garbage from the discharge pipe line 4b.

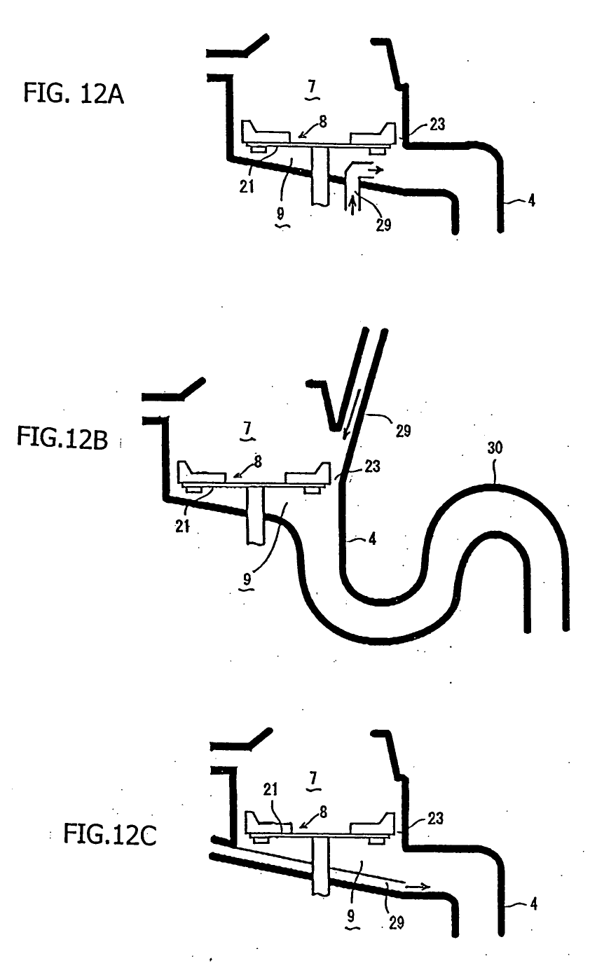

FIGS. 12(a) through (c) are views describing examples of other water supply means (discharge section jet), respectively. An example as shown in FIG. 12(a) has a structure in which the discharge section jet 29 directed toward a connecting section of the discharge pipe line 4 is connected to the bottom section of the discharge section 9. In an example as shown in FIG. 12(b), the discharge pipe line 4 is connected to the bottom section of the discharge section 9, and the discharge section jet 29 which emits a jet of water to the discharge pipe line 4 from above is provided on the side surface of the discharge section 9. In an example as shown in FIG. 12(c), the discharge pipe line 4 is also connected to the bottom section of the discharge section 9, and the discharge section jet 29 which emits a jet of water toward this discharge pipe line 4 is provided along the bottom surface of the discharge section 9.

By synchronizing the discharge section jet 29 serving as the water supply means with the means for controlling the amount of garbage passing through the clearance so as to increase the amount of garbage discharged within the discharge section or on the downstream side of the discharge section in response to the decrease in the amount of garbage passing through the clearance, it is possible not only to improve the discharge performance, but also to improve homogenization of crushed substance concentration, thereby preventing clogging.

Referring back to FIG. 1, the discharge pipe line 4 is provided with an S-shaped trap section 30 for sealing water. This trap section 30 can be provided with a water supply means (discharge section jet) 29 to improve the discharge performance.

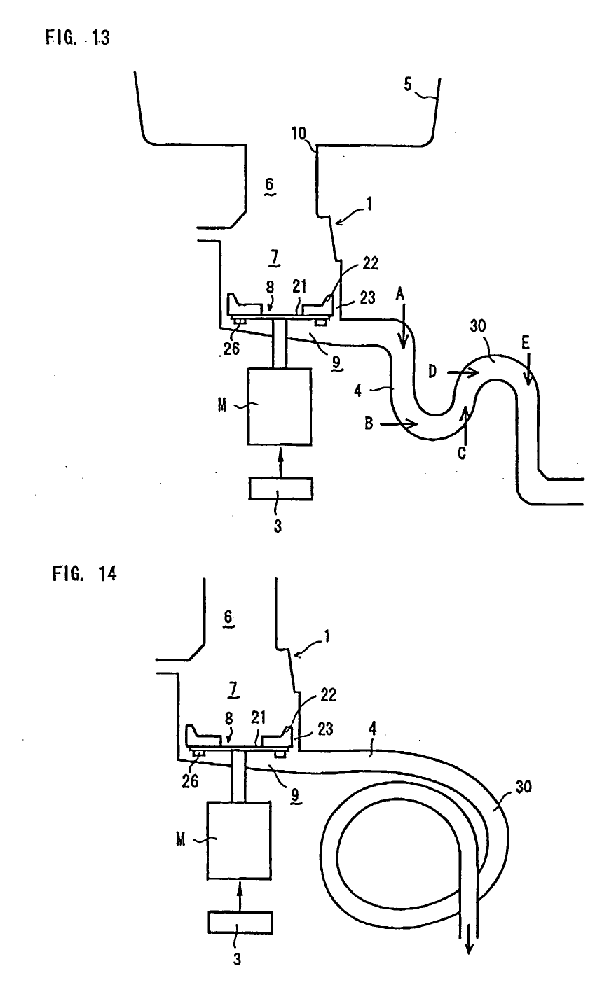

Specifically, as shown in FIG. 13, the discharge section jets ejecting water in the arrow direction are provided at five (5) places A through E. A discharge section jet can be arranged at only one place A through E. However, in the case where the discharge section jets are arranged at all five places, a water-saving effect can be expected by turning the jets ON in order of A→B→C→D→E without driving all the jets at once. Only water can be emitted from the discharge section jets, but a mixture of water and air or only air can be emitted for water saving. The jet direction can be arranged to swivel spirally along the inner surface of the discharge pipe line 4 so as to heighten the extrusive force, or the jet of water can be emitted in the opposite direction to prevent clogging. By synchronizing the discharge section jets serving as the water supply means with the means for controlling the amount of garbage passing through the clearance so as to increase the amount of garbage discharged within the discharge section or on the downstream side of the discharge section in response to the decrease (reduction) in the amount of garbage passing through the clearance, it is possible not only to improve the discharge performance, but also to achieve homogenization in the crushed substance concentration, thereby preventing clogging.

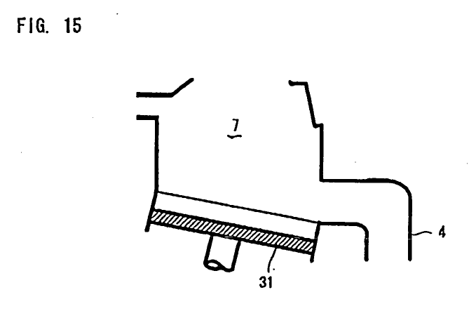

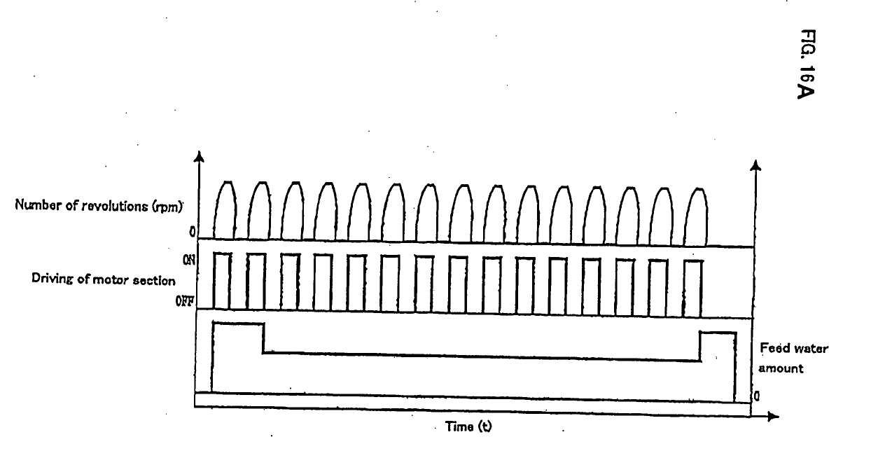

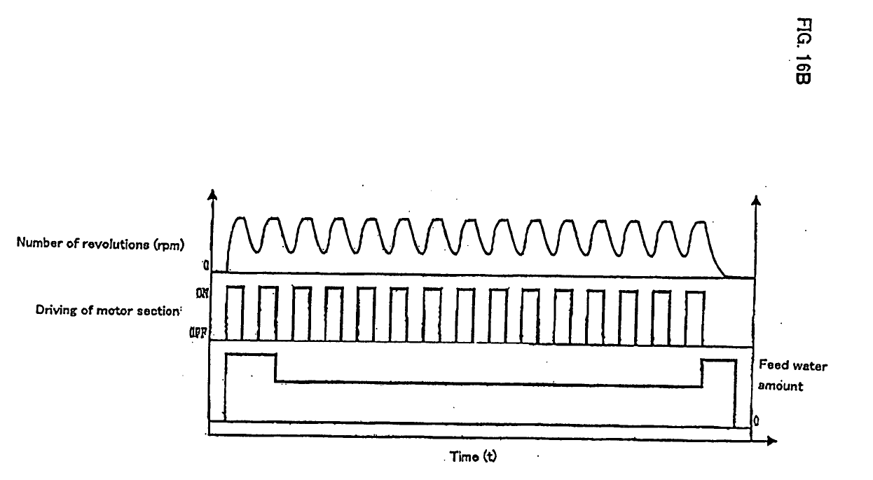

FIGS. 14 and 15 are views showing one example of a means for controlling the amount of garbage discharged, respectively. In the example as shown in FIG. 14, a trap section is formed in a loop shape with a large curvature to prevent clogging.

A trap section 30 can be partially deformed to change the volume within the trap section 30. For example, while the turntable is rotating, the flow channel diameter of the trap section 30 can be narrowed to control the discharge so that the garbage is fully crushed. The flow channel diameter of the trap section 30 is enlarged, when the turntable stops, to improve the discharge capability. For example, the flow channel diameter can be adjusted by wringing the trap section 30 made of flexible material by an actuator. Further, a pipe, of which the cross section is oval-shaped, forming the trap section 30, can be adopted.

In the example as shown in FIG. 15, part of the discharge section 9 is a movable plate 31 to change the volume of the discharge section 9. For example, while the turntable is rotating, the movable plate 31 is caused to move backward to enlarge the volume within the discharge section to control the discharge until the garbage can be fully crushed. The movable plate 31 is then caused to move forward, when the turntable stops, to reduce the volume within the discharge section 9 to improve the discharge capability.

In addition to the above, the means for controlling the amount of garbage discharged within the discharge section or within the trap section 30 on the downstream side of the discharge section 9 can be a flapper valve and the like. By synchronizing the flapper valve with the means for controlling the amount of garbage passing through the clearance so as to increase the amount of garbage discharged within the discharge section or on the downstream side of the discharge section in response to the decrease (reduction) in the amount of garbage passing through the clearance, it is possible not only to improve the discharge performance, but also to achieve homogenization of the crushed substance concentration, thereby preventing clogging.

It is to be noted that the present invention can also include a combination of the various embodiments stated above.

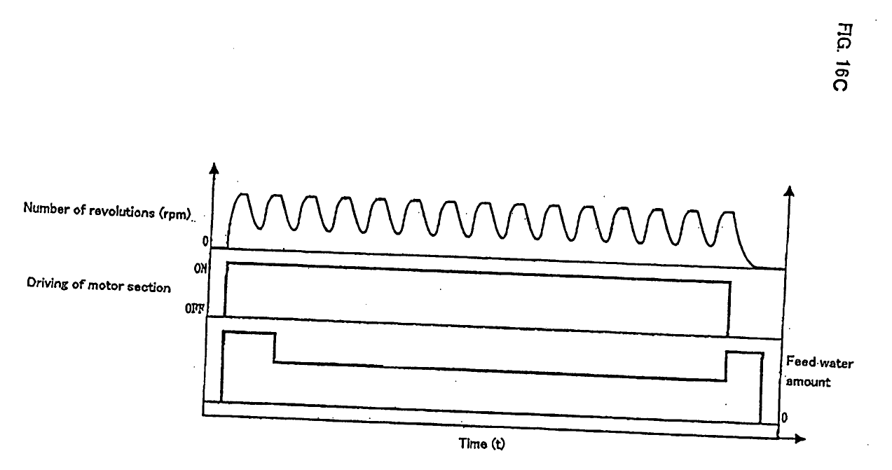

One example of an operating pattern of the garbage disposal apparatus as constructed above will now be described. FIG. 16 is a view showing an operating pattern in which the ON/OFF state of the driving motor and the feed water amount are varied. In this embodiment, an AC motor which rotates at 1500-1800 revolutions per minute is used as a motor M. A motor control section 3 is provided with a snubber circuit for controlling electric noise resulting from the ON/OFF switching.

In an operation example as shown in FIG. 16a, an equally pitched operation of 2 seconds ON (high speed revolution) and 2 seconds OFF (stop) is repeated from the start to the end of operation, while the feed water amount (water supply) from the feed water section 2 is increased for about 5 seconds from the start of operation and for about 5 seconds from the end of operation, and is decreased in the intermediate position.

In an operation example as shown in FIG. 16b, an equally pitched operation of 2 seconds ON (high speed revolution) and 2 seconds OFF (low speed revolution) is repeated from the start to the end of operation, while the feed water amount from the feed water section 2 is increased for about 5 seconds from the start of operation and for about 5 seconds from the end of operation, and is decreased in the intermediate position.

In an operation example as shown in FIG. 16c, the motor is always ON from the start to the end of operation, but high speed revolution and low speed operation are repeated every 2 seconds, while the feed water amount from the feed water section 2 is increased for about 5 seconds from the start of operation and for about 5 seconds from the end of operation, and is decreased in the intermediate position.

Generally, the life span of a motor is often dependent on a relay or the like which is switched ON or OFF within the motor. In order to extend the life span of the motor, it is desirable that frequency of the ON/OFF switching be reduced. In the above-mentioned embodiments, the life span of the motor can be extended because the number of revolutions of the motor is always varied in the ON state. Such control can be easily achieved by the use of a DC motor.

The crushed substance passing through the clearance 23 between the turntable 21 and the fixed blade 22 per unit of time is increased immediately after the start of operation, which causes clogging on the downstream side. However, by conducting a variable operation, the concentration of garbage immediately after the start of operation is decreased. The concentration of garbage is also decreased by increasing the feed water amount immediately after the start of operation.

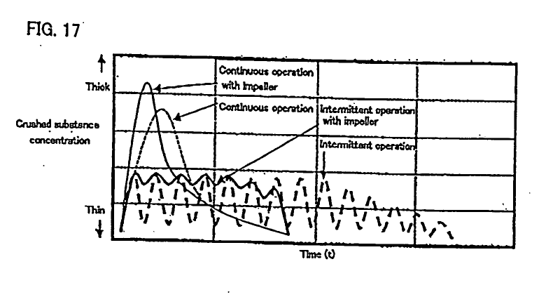

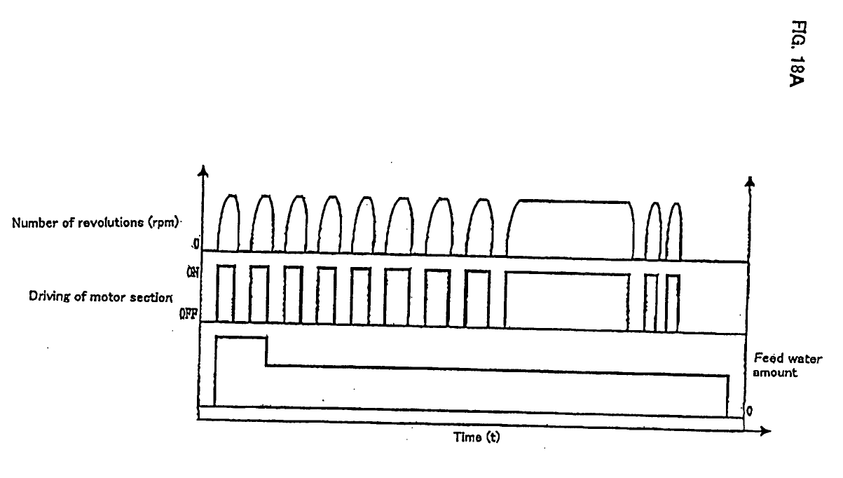

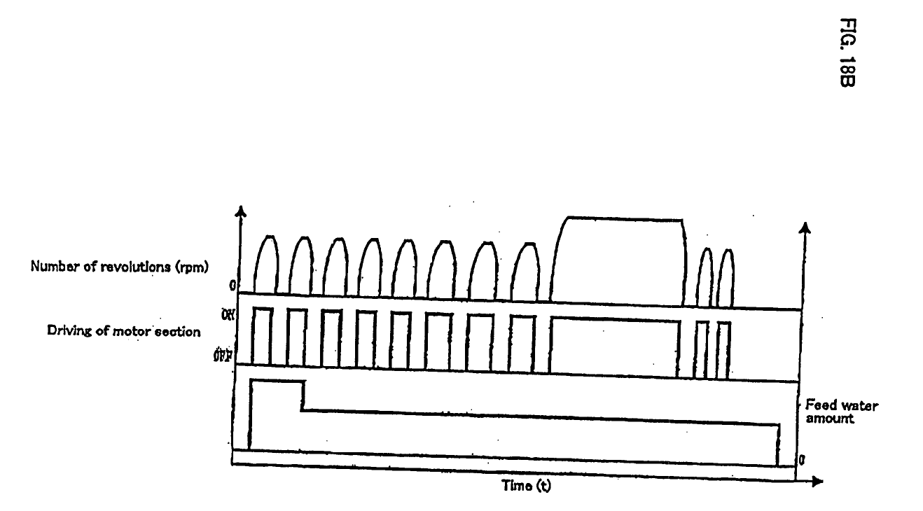

FIG. 17 is a graph comparing the relationship between the concentration of crushed materials passing through the clearance and the time from the start of continuous operation with the impeller, continuous operation without the impeller, variable operation with the impeller, and variable operation without the impeller. As is obvious from this graph, in the case of continuous operation, the concentration of the crushed substance in the initial stage of operation suddenly rises with or without the impeller, which is likely to cause clogging. On the other hand, in the case of variable operation without the impeller, the concentration of the crushed materials suddenly drops in the OF state and it takes a long time to fully discharge the garbage. However, by conducting the variable operation with the impeller as seen in the present invention, the concentration of crushed materials from the start to the end of operation substantially converges with a steady value.

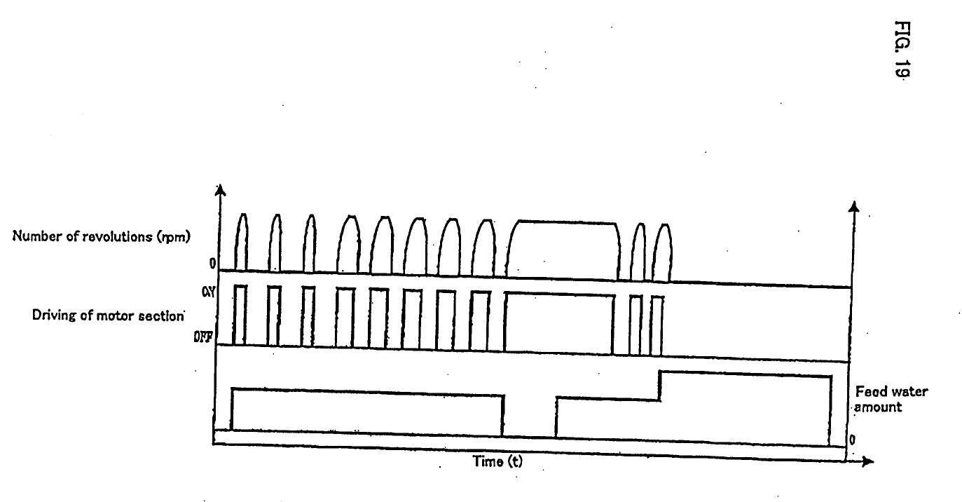

FIGS. 18a through 21 are views showing another embodiment of an operation pattern, respectively. In the embodiment as shown in FIG. 18a, for the motor, the ON interval in the middle of operation is 3 seconds, a comparatively long ON state of 15 seconds is provided in the second half of operation, and finally, an ON state of 1 second is conducted twice. The feed water amount is increased only immediately after the start of operation. In this manner, by increasing the feed water amount immediately after the start of operation, the garbage concentration can be lowered to prevent clogging. Finally, a short variable operation is conducted to prevent the garbage from being deposited in the discharge port.

Referring to the embodiment as shown in FIG. 18b, for the motor, the number of revolutions is caused to increase for a comparatively long ON state of 15 seconds in the latter half of the operation. In this manner, by adjusting the number of revolutions of the turntable, the crushing capability can be controlled. Thus, homogenization of the crushed substance concentration is achieved and clogging can be prevented.

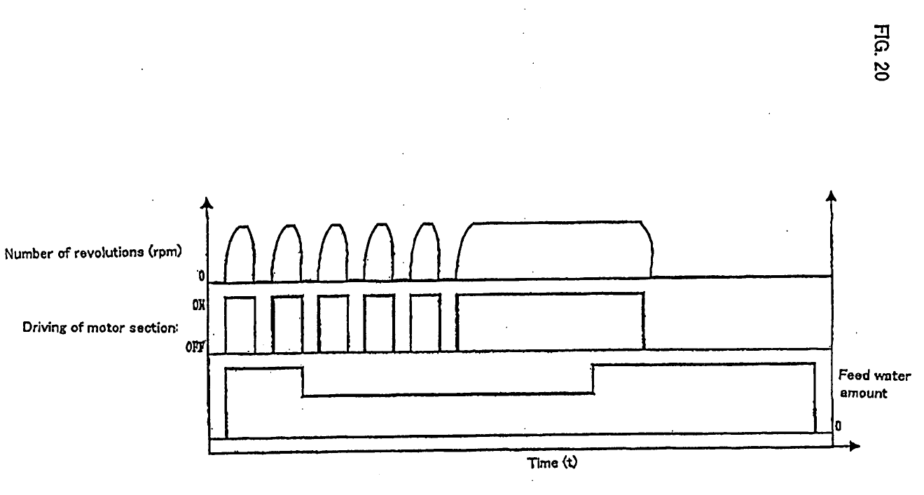

Referring to the operation pattern as shown in FIG. 19, for the motor, the ON state immediately after the start of operation is set short (1 second) as compared to the patterns of FIG. 18. The feed water is stopped once in the second half of the operation, and after the motor is switched off, a large amount of water is further supplied. By stopping the feed water once, it is also possible to crush garbage such as grapefruit peel which has a specific gravity so light that the peel floats within the crushing section and which is crushed with difficulty.

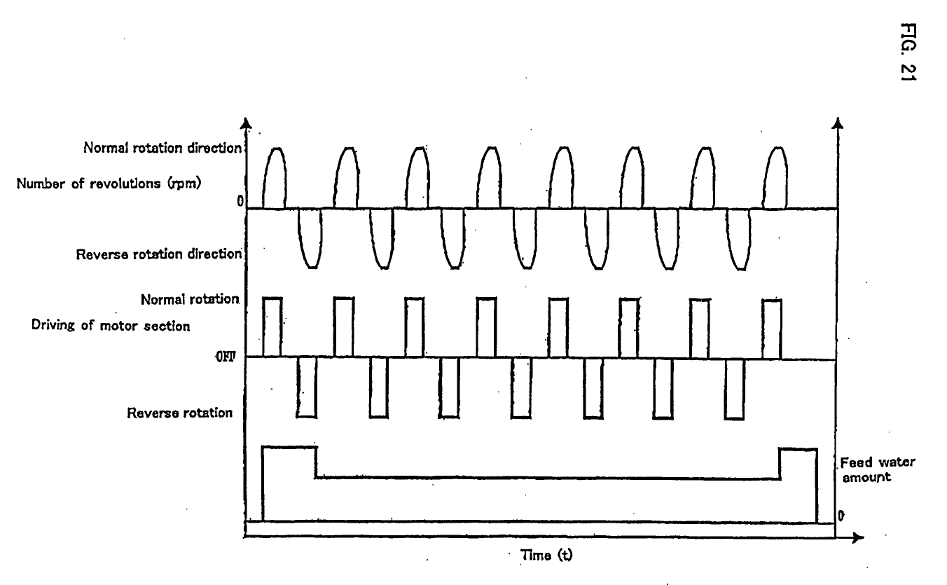

Referring to the operation pattern as shown in FIG. 20, for a motor, an ON state of about 3 seconds is produced several times in the first half of the operation and the an ON state of about 30 seconds is provided in the second half of the operation. A large amount of feed water is continuously supplied in the second half. This pattern excels in durability of relay because the frequency of the ON/OFF state is less.

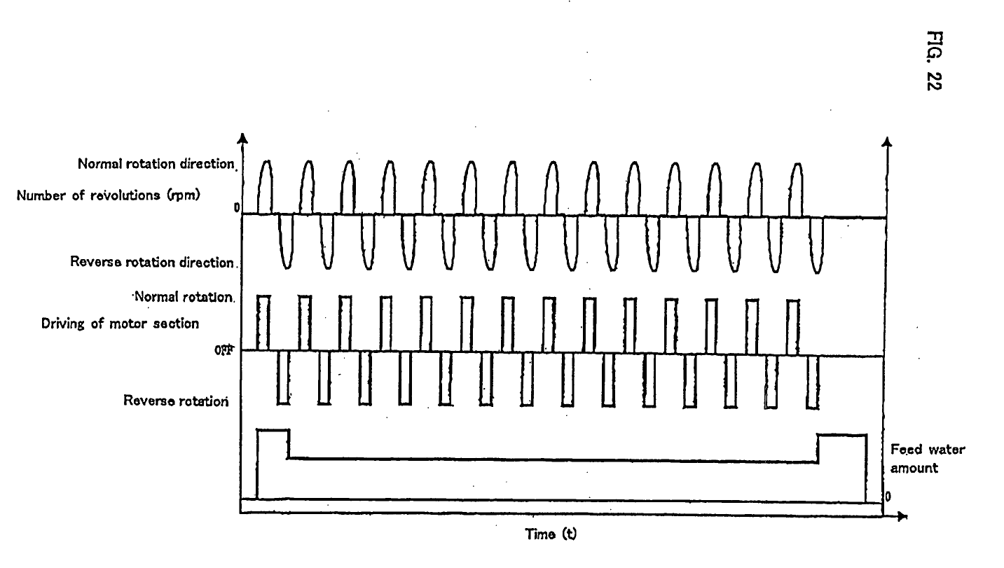

Referring further to the operation patterns as shown in FIGS. 21 and 22, reverse rotation is provided between the ON and OFF states. By such a reversal, tangled fibrous garbage can be unraveled. In the pattern as shown in FIG. 21, the ON/OFF reverse operating interval is set at about 2 seconds, but in the pattern as shown in FIG. 22, the ON/OFF reverse operating interval is set at about 1 second.

Further, by synchronizing the number of revolutions (ON/OFF control) of the turntable 21 with the water supply means (discharge section jet) so as to increase the amount of garbage discharged within the discharge section or on the downstream side of the discharge section in response to the decrease (reduction) in the amount of garbage passing through the clearance, uniform discharge is possible. In other words, if the feed water amount from the water supply means (discharge section jet) is increased in response to the decrease in the number of revolutions of the turntable 21, it is possible to achieve homogenization of the crushed materials concentration and clogging can be prevented.

As the number of revolutions of the turntable 21 increases, an amount of movement (moving distance) increases. Accordingly, the water supply means (discharge section jet) 29 can be driven to discharge garbage provided the number of revolutions has reached a steady value or more.

Further, in the case where clogging is detected by a microwave sensor 18 and a pressure sensor 19 which detect the volume of water in the garbage storing chamber 7, or by a clogging sensor provided at the discharge section 9, the discharge pipe line 4, or the trap section 30, the start or flow volume increase of the discharge section jet and the trap section jet, the start of rotation or increase in the number of revolutions of the impeller 26, a reduction in the opening of the flapper valve, the start or flow volume increase of the reverse flow jet, a volume change of the discharge section 9, a shape change of the trap section and the like can be initiated to clear the clogging.

Still further, if the discharge section jet, the trap section jet, the impeller and the means for controlling the amount of garbage passing through the clearance are synchronized, homogenization of the crushed materials concentration is achieved and thus, clogging can be prevented.

It is also possible to detect the amount of garbage deposited into the garbage storing chamber from the running torque of the turntable to control the crush control means.

The operating pattern is not limited to the examples stated above if the crushed substance is surely discharged during the short operating time of about 60 seconds.

### Effects of the Invention

According to the present invention, even garbage containing long fibrous materials does not intertwine to cause clogging at a discharge port or at a trap section on the downstream side of the discharge port, and the crushing and discharging processes can be conducted in a comparatively short period of time.

1. A garbage disposal apparatus comprising:
a garbage disposition port;
a storage chamber communicating with the garbage disposition port to store uncrushed garbage and into which flushing water is supplied;
a crushing section provided adjacent to the storage chamber and having a crushing mechanism and a clearance for passing therethrough the garbage crushed by the crushing mechanism;
a discharge section provided in communication with the clearance and having a discharge port for externally discharging the garbage crushed by the crushing section;
a driving mechanism for driving the crushing mechanism;
a mechanism for controlling the amount of garbage passing through the clearance per unit of time; and
a mechanism provided at the discharge section or on a downstream side of the discharge section for controlling the amount of garbage discharged within the discharge section or on the downstream side the discharge section.

2. The garbage disposal apparatus according to claim 1, wherein in order to bring the concentration of the crushed garbage in the discharged water close to a steady value for a predetermined time from the start of discharge to the end of discharge, the mechanism for controlling the amount of garbage passing through the clearance per unit of time is driven in synchronization with the mechanism for controlling the amount of garbage discharged within the discharge section or on the downstream side of the discharge section.

3. The garbage disposal apparatus according to claim 1, wherein the mechanism for controlling the amount of garbage passing through the clearance per unit of time is a crush controlling mechanism for controlling the drive condition of the crushing mechanism.

4. The garbage disposal apparatus according to claim 3, wherein the crushing mechanism is composed of a turntable and a rotary blade mounted on the turntable.

5. The garbage disposal apparatus according to claim 1, wherein the mechanism for controlling the amount of garbage passing through the clearance per unit of time is an automatic feed water mechanism for adjusting the amount of flushing water to be supplied to the storage chamber.

6. The garbage disposal apparatus according to claim 1, wherein the mechanism for controlling the amount of garbage passing through the clearance per unit of time is a clearance adjusting mechanism for changing the size of the clearance.

7. The garbage disposal apparatus according to claim 1, wherein the mechanism for controlling the amount of garbage passing through the clearance per unit of time is a garbage disposition amount regulating mechanism for regulating the amount of garbage supplied to the crushing section provided in the storage chamber and a control mechanism for controlling the garbage disposition amount regulating mechanism.

8. The garbage disposal apparatus according to claim 1, wherein the mechanism for controlling the amount of garbage discharged within the discharge section or on the downstream side of the discharge section is an impeller adapted to rotate integrally with or separately from the crushing mechanism.

9. The garbage disposal apparatus according to claim 8, wherein the impeller is installed on an under surface of a turntable, and the angle of the impeller is arranged so that the front end section is situated radially inside relative to the rotative direction and the rear end section is situated radially outside to be set back from the radial direction of the front end section.

10. The garbage disposal apparatus according to claim 1, wherein the mechanism for controlling the amount of garbage discharged within the discharge section or on the downstream side of the discharge section is a water supply mechanism for emitting a jet of water.

11. The garbage disposal apparatus according to claim 10, wherein the emitting direction of the jet of water by the water supply mechanism is a direction to accelerate the flow to the discharge port.

12. The garbage disposal apparatus according to any claim 1, wherein the mechanism for controlling the amount of garbage discharged within the discharge section or on the downstream side of the discharge section is a water supply mechanism for emitting a jet of water from a predetermined direction to a trap section on the downstream side of the discharge port.

13. The garbage disposal apparatus according to claim 1, wherein the mechanism for controlling the amount of garbage discharged within the discharge section or on the downstream side of the discharge section is a pump for pumping out a fluid.

14. The garbage disposal apparatus according to claim 3, wherein the crush control mechanism for controlling the drive condition of the crushing mechanism is a motor control section for controlling a revolving speed and an operating time of the crushing mechanism, and the control by the motor control section is a variable operation whereby stoppage, low speed revolution, or high speed revolution are rotatingly repeated.

15. The garbage disposal apparatus according to claim 14, wherein the mechanism for controlling the amount of garbage discharged within the discharge section or on the downstream side of the discharge section is an impeller adapted to rotate integrally with or separately from the crushing mechanism.

16. The garbage disposal apparatus according to claim 3, wherein the crush control mechanism for controlling the drive condition of the crushing mechanism is a motor control section for controlling a revolving speed and an operating time of the crushing mechanism, and the control by the motor control section is a variable operation whereby stoppage, low speed revolution, or high speed revolution are rotatingly repeated.

17. The garbage disposal apparatus according to claim 3, wherein the crush control mechanism for controlling the drive condition of the crushing mechanism is a motor control section for controlling a revolving speed and an operating time of the crushing mechanism, the control by the motor control section is a variable operation whereby stoppage, low speed revolution, or high speed revolution are rotatingly repeated, and the operating time of the last or proximate high speed revolution is longer than that of other high speed revolutions.

18. The garbage disposal apparatus according to claim 14, wherein the mechanism for controlling the amount of garbage passing through the clearance per unit of time is an automatic feed water mechanism for adjusting the amount of flushing water to be supplied to the storage chamber, and the amount of flushing water to be supplied by the automatic feed water mechanism is increased immediately after the start of the variable operation.

19. The garbage disposal apparatus according to claim 14, wherein the mechanism for controlling the amount of garbage passing through the clearance per unit of time is an automatic feed water mechanism for adjusting the amount of flushing water to be supplied to the storage chamber, and the amount of flushing water to be supplied by the automatic feed water mechanism is stopped once in the middle of the variable operation.

20. The garbage disposal apparatus according to claim 14, wherein the mechanism for controlling the amount of garbage passing through the clearance per unit of time is an automatic feed water mechanism for adjusting the amount of flushing water to be supplied to the storage chamber, and the amount of flushing water to be supplied by the automatic feed water means mechanism is continued for a predetermined period of time after the variable operation is completed.

21. The garbage disposal apparatus according to claim 14, wherein the crushing mechanism is composed of a turntable and a rotary blade mounted on the turntable, the mechanism for controlling the amount of garbage passing through the clearance per unit of time is an automatic feed water mechanism for adjusting the amount of flushing water to be supplied to the storage chamber, and the water supply means is driven in synchronization with the control of the number of revolutions of the turntable so that the amount of water supply from the water supply mechanism is increased in response to the decrease in the number of revolutions of the turntable.
